(19) United States
(12) Patent Application Publication
(10) Pub. No.: US 2010/0042476 A1
(43) Pub. Date: Feb. 18, 2010

(54) METHOD AND SYSTEM FOR TARGET MARKETING AND CATEGORY BASED SEARCH

(76) Inventor: Dinesh K. Gauri, Jamesville, NY (US)

Correspondence Address: BASCH & NICKERSON LLP, 1777 PENFIELD ROAD, PENFIELD, NY, 14526, US

(21) Appl. No.: 12/540,965

(22) Filed: Aug. 13, 2009

Related U.S. Application Data
(60) Provisional application No. 61/088,850, filed on Aug. 14, 2008.

(51) Int. Cl. G06Q 30/00; G06Q 10/00

(52) U.S. Cl. 705/10; 705/26; 705/14.52; 705/14.45; 705/14.23; 705/14.19; 705/14.16

(57) ABSTRACT

Disclosed are a system and methods for online marketing of goods and services to consumers. More particularly, a method for target marketing to specific consumers on the Internet based upon the profile of the consumer, including geographic location, is disclosed.

This application claims priority from the following Provisional Application, which is also hereby incorporated by reference in its entirety, “METHOD AND SYSTEM FOR TARGET MARKETING AND CATEGORY BASED SEARCH” by Dinesh K. Gauri application No. 61/088,850 filed on Aug. 14, 2008.

The present disclosure relates to online marketing of goods and services to consumers. More particularly, a method for target marketing to specific consumers on the Internet based upon the profile of the consumer is disclosed.

### BACKGROUND AND SUMMARY

The Internet has opened the door to a new channel for retailers to reach out to potential consumers by displaying advertisements on websites. For example, a website can dynamically display a banner advertisement to a person who browses the website. In this way, a website can be used to promote a number of different products and services over the World Wide Web.

However, the main limitation of Internet advertising is that it is difficult to target advertisements to the relevant audience. Several methods have been devised for target advertising by understanding the characteristics of the audience for these advertisements. Retailers use data on spending habits, demographics, behavior patterns and other information of potential consumers, who browse these websites, to effectively advertise the products and services.

One method of target advertising on the Internet includes directing of sale offers to potential consumers through e-mails. A second method is the use of web browser cookie files to target banner advertisements by tracking the activities of the consumer, when the consumer surfs the Internet. Cookie files typically include information regarding the websites that a consumer has browsed through, and are installed by the website server on the computer hard disk drive of a browsing consumer. For example, when a user visits an electronics retailer website, this information may be retrieved from the cookie and used to direct electronics related advertisements to the user. A third method to identify users that may be the relevant consumers for the products and services of the retailer is to monitor the user activity using software installed on the user's system, to profile the user. The software is provided by the service provider to the consumer for profiling. Also, there are methods which require the consumer to register and create a profile which may include details of the interests of the consumer. Based on these details, the retailers provide customized offers to the consumer for various goods and services that may be of interest to consumers, each time the consumer logs on to the website.

Further, there are methods which enable a retailer to identify particular consumer groups and particular consumer needs, and then provide targeted advertisements to these identified groups. This is done by capturing the unique consumer knowledge of an Internet Service Provider (ISP) with respect to the consumer's identity, spending habits, likes and dislikes, browsing history etc. The retailers may direct customized offers to consumers while preserving consumer privacy through the use of these methods.

Also, there are methods which may combine the abovementioned methods with real-time promotional offers over the Internet. For example, there are methods which combine search engine with target advertising. When a consumer conducts a search using a web based search engine like GOOGLE™ or YAHOO™, the search terms may be used to select advertisements to be shown to the consumer in real time or indeed directly determine the advertisement itself. For example, when a user enters search terms using a search engine website, an AMAZON.COM® advertisement appears on the web page of the search engine, inviting the user to search Amazon.com for products related to the search term.

All the abovementioned methods enable retailers to communicate offers directly to potential consumers in real-time and without having the knowledge of consumer's identity. However these methods do not provide enough incentive for the consumer to use these services and, therefore, are not very popular with the consumers. Hence, there have been various attempts for providing incentives to the consumers by various websites for using the services offered by them. These incentives are given in terms of reward points, which can be earned for the purchases done through the website or as an incentive from the retailer for enhancing the consumer loyalty. The existing methods provide incentives only to a class of consumers who meet predetermined criteria like a minimum purchase order or a minimum number of purchases made through the website.

There also exist methods for providing incentives through coupons that are targeted to individual consumers with the coupons containing promotional material and recommendations. Also, methods for generating and redeeming discount coupons for a selected consumer; and selecting future coupons for the selected consumer based on the coupons previously redeemed by the consumer are known. Websites which reward user based on the time spent by the user in browsing the website are also known. These reward points can be redeemed in terms of cash or as discount or promotional coupons. The primary object of all these methods is to induce the consumer to shop at a retailer registered with the website and increase the total purchases from that retailer.

The abovementioned methods are predominantly for target marketing to the consumer based on the data and providing incentives to the consumer in terms of reward points and discount coupons. However, all the methods mentioned above deal with a single retailer system and do not discuss or deal with an interface for multiple retailers. Also, the reward points provided by a retailer to the consumer may only be redeemed for buying the products and services from this retailer and may not be used for buying products and services from other retailers.

In light of the above mentioned limitations of the existing systems and methods, what is required is a way to effectively target specific consumers for marketing of specific products and service from specific retailers. Further, there is a need for a method that allows consumers to receive advertisements for products and services from multiple retailers, which enables a consumer to receive the best deal on desired products and services. Also, there is a need for a central reward system for redeeming the reward points earned by a consumer from multiple different retailers. Finally, there is a need to increase consumer response to offers provided by the retailers.

An object of the disclosed embodiments is to provide promotional offers based on past online behavior of consumers. Past behavior includes without limitations the browsing habits, the funds spent and the interests of the consumer.

Another object of the disclosed embodiments is to provide for a method of rewarding users for activities including browsing various websites, referring people, using coupons, participating in online surveys, entering reviews and buying more on partner websites.

Another object of the disclosed embodiments is to provide a mechanism to get rankings of websites based on popularity of websites at an aggregate or disaggregate level. User can also access information of popular websites based on search terms.

Another object of the disclosed embodiments is to provide a reward point system in which an owner can swap their reward points between two different loyalty card programs.

In order to meet the above objectives the systems and methods disclosed herein provide targeted online marketing. The system comprises an application that runs on a website (server) and operates in conjunction and communication with downloaded software that runs on local workstation (client). In various embodiments, the downloaded software may operate in the manner of a toolbar or messenger-like application that runs on the workstation, providing a common platform to consumers and retailers for interaction. The system is targeted to consumers based on a number of factors, which may include the browsing and shopping behavior of the consumer on the website, as well as demographic and psychographic profile of the consumer.

### BRIEF DESCRIPTION OF THE DRAWINGS

FIG. 1 is a schematic diagram showing a system for targeted online marketing according to a disclosed embodiment and the environment in which the system operates;

FIG. 2 illustrates a method of creating a consumer profile on the system according to one embodiment;

FIG. 3 represents a schematic diagram of various services offered by the system for targeted online marketing according to one embodiment;

FIGS. 4 and 5 are exemplary illustrations of a web browser interface for aspects of the disclosed embodiments;

FIG. 6 is an example of the manner in which points are accumulated in accordance with a disclosed embodiment;

FIGS. 7-14 are exemplary user interface screens for an embodiment of the disclosed system and methods;

FIGS. 15-19, are also exemplary interface screens associated with a retailer user of the system;

FIG. 20 is an exemplary interface screen setting out membership options and point reward programs in accordance with an aspect of the disclsed embodiments;

FIG. 21 is an illustration of an interface screen with a user toolbar;

FIGS. 22 and 23 are illustrations of database schemas in accordance with aspects of the disclosed embodiments; and

FIG. 24 is a schematic illustration of the operation of aspects of the disclosed embodiments.

### DETAILED DESCRIPTION

In the following description, for the purposes of explanation, specific details are set forth in order to provide a thorough understanding of the disclosed embodiments. However, it will be apparent that the systems and methods may be practiced without these specific details. Various aspects and features of example embodiments are described in more detail hereinafter.

A system and a method for targeted online marketing are disclosed. The system comprises an application that runs on a website, providing a common platform to consumers and retailers for interaction. Various services provided by the website have been discussed in the disclosure.

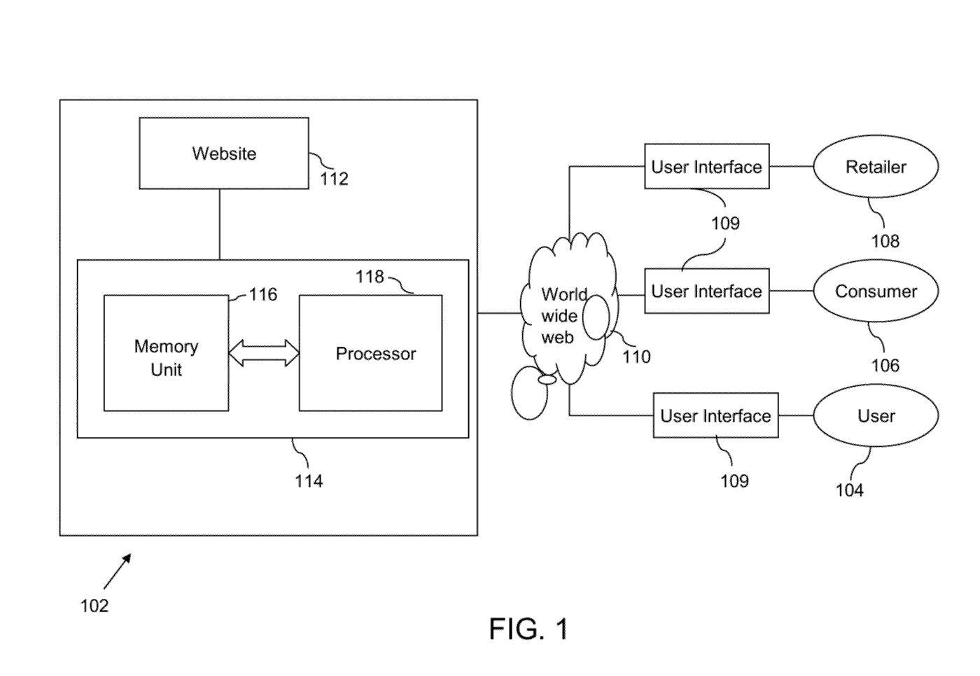

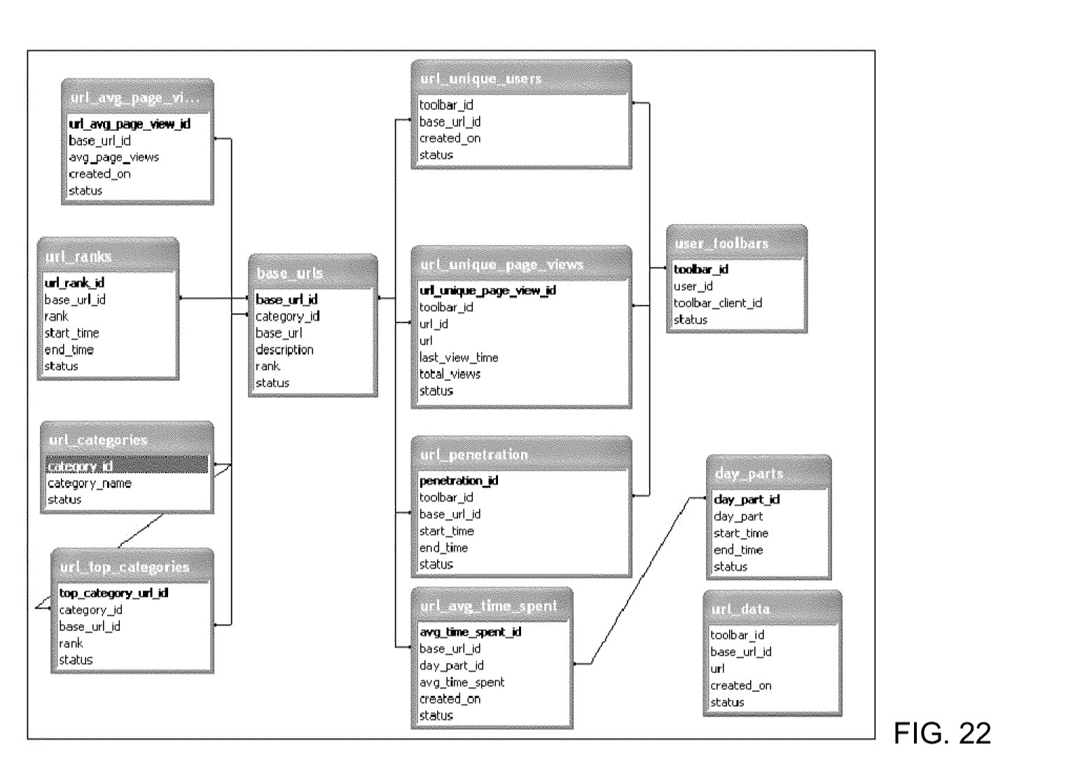

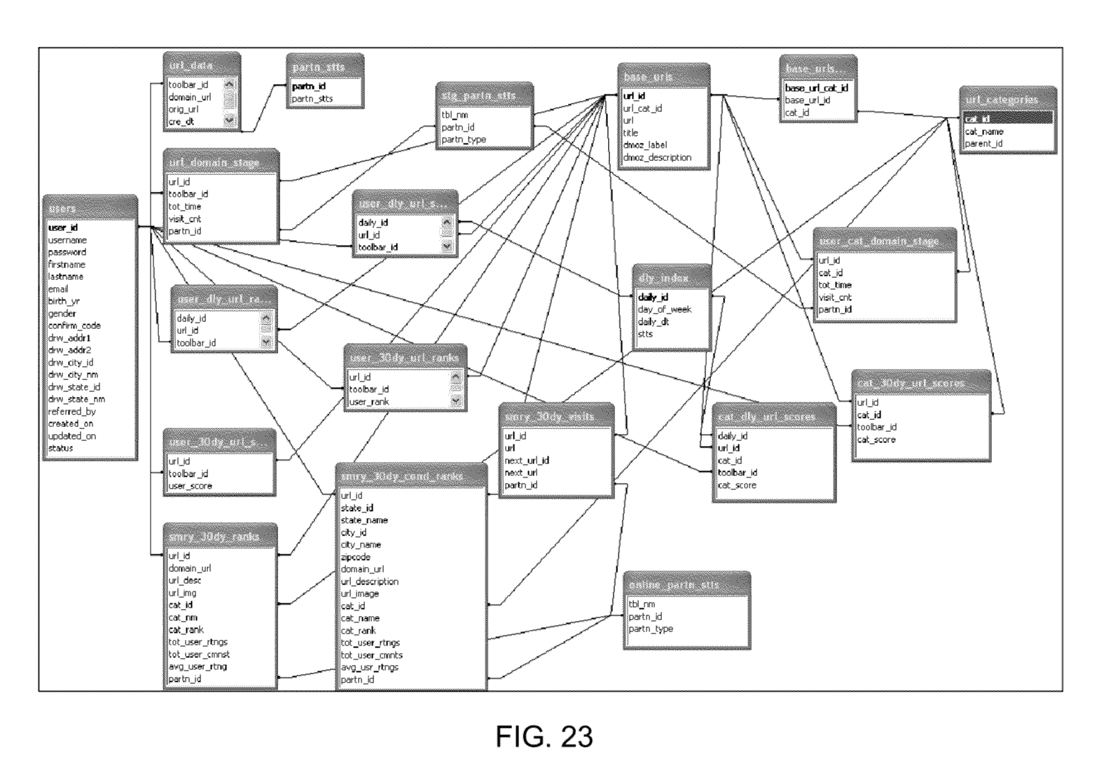

The system may be embodied in a variety of different types of hardware and software using combinations of both server-side and client-side hardware and software components, as is readily understood by those of skill in the art. Referring to FIG. 1, in one embodiment, the system 102 operates a server 114 serving pages to clients, and includes one or more databases with which information is exchanged (stored and retrieved) in order to provide updated data to the clients. Examples of such databases are found in FIGS. 22-23, where by the descriptive terms applied to the various database tables and the data fields therein it will be understood the nature of the data being stored as well as the relationships between the tables. In particular, the tables are used to store various types of information like user information, site statistics, retailer information, coupons or promotions, etc. Moreover, the clients include retailers as well as consumers.

FIG. 1 is a schematic diagram showing a system for targeted online marketing according to an embodiment and the environment in which the system operates. System 102 interacts with clients such as a user 104, consumers 106 and retailers 108 through a World Wide Web 110 or similar client-server or other interface/protocol. Such a system may include a computer server suitably connected to the Internet so as to receive and transmit information via TCP/IP or similar protocols. The server 114 may run one of several known operating systems such as MICROSOFT® WINDOWS™, Unix or the like, and provide for local or remote administration of the server operations, as well as programmatic serving of web pages in response to client requests.

According to one embodiment, system 102 comprises a website 112 hosted on a website hosting server 114. Web hosting server 114 provides Internet hosting service allowing individuals and organizations to provide their own websites accessible via World Wide Web 110. Furthermore, website hosting server 114 comprises a memory unit 116 and a processor 118. Memory unit 116 stores software in the form or programmatic instructions to be executed by the processor 118. Also stored in memory associated with the processor (which may be memory 116 or other accessible media, etc.) are user profiles and statistics related to the use system 112 by users 104, consumers 106 and retailers 108. Such information is stored in memory in one or more databases, or similar data structures, as described below. The following lists are illustrative examples of the types of information (fields) that may be stored in the database records for both users/consumers and retailers:

### User/Consumer Information Record

a. Name of user/consumer

b. Year of Birth

c. Gender

d. Address from where Internet accessed (at least a zip code) (The present system and methods contemplate using a check of the user address when the user is taking part in the sweepstake conducted at regular intervals.)

e. Login Id

f. Password

g. E-mail Address

h. When the user is in track mode
1. Time spent by the user on any site
2. Number of pages viewed
3. Reviews entered
4. Advertisements/Promotions/Surveys clicked and availed
5. Products Purchased at partner sites/retailers

### Retailer Information Record

a. Name of Retailer

b. Contact Phone Number

c. Contact Address

d. Best time to Call

e. Brief Requirement

f. Login Id

g. Password

h. Email Address

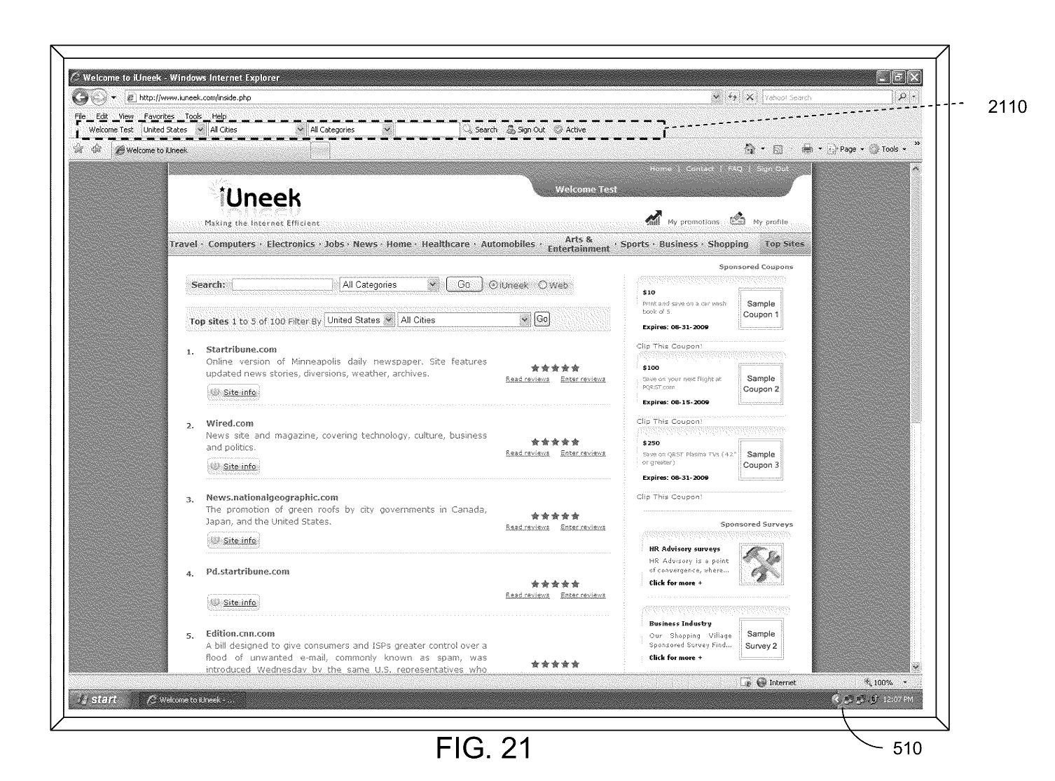

Once a user's account (which may include consumer, retailer, administrator accounts) is created and upon login, the user's information is uploaded when the user is logged-in to the system. As noted previously, the user's information is updated via a toolbar (e.g., FIG. 21, toolbar 2110) or similar desktop application, browser add-on or the like so that the user's workstation (client) sends information. It will be further appreciated that a user's information may be tracked via a cookie or similar type of localized storage and periodically uploaded to the server when the user is logged in.

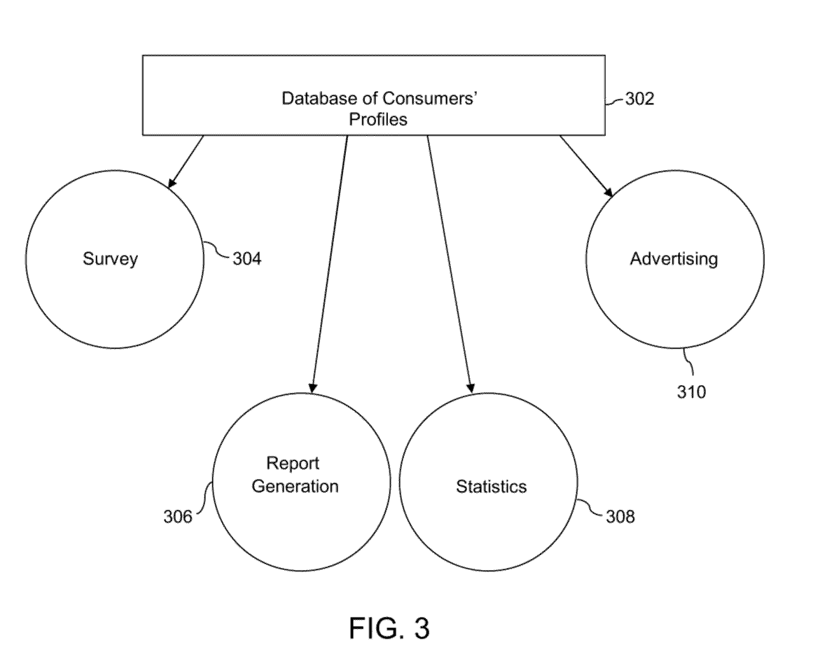

The software may be a collection of computer programs, procedures and associated graphics or images suitable for maintaining and running the web-based system 112. Website hosting server 114 also may include or be operatively associated with a web search engine unit which is described in conjunction with FIG. 3. A web search engine searches for information on World Wide Web 110.

In one embodiment of the system there is contemplated a loyalty card program for various retailers, where a user's (e.g., consumer) use of the system accumulates points at one or more of various retailers that participate in the system. It may also be possible for user's to transfer pre-existing or otherwise-accumulated reward points to their own account, at a predefined conversion factor, and to then be able to use the points at a centralized location—for example, to shop at the on-line retailers that participate in the system. As with the consumers themselves, the retailers are also members, and the conversion factor (including a straight percentage conversation, tiered or level conversion based upon points being transferred, etc.) may be negotiated. In any event, the retailer would provide data as to the user/consumer's number of accumulated points available for transfer. The network connection (Internet) is one method of receiving the reward point information, as well as direct connections, media exchange, etc.). The operative aspect of the connection to a retailer is that consumer data related to the reward points, purchases, etc. is fed from the retailer and uploaded to the system 112, thereby indicating that the consumer made a purchase(s) and to add points.

In one embodiment, the system may be implemented as software incorporated in a computer system using a Windows, Macintosh, UNIX, Linux or other operating system equipped with a Web browser application, or other Web-enabled device capable of connecting to the Internet or other network system. It should be noted that the term “Internet” is intended to encompass similar systems and nomenclature (i.e., World Wide Web or “www”) comprising the capability to communicate and access information through a network, telephone connections, ISDN connections, DSL connections, cable modem, fiber optic network, etc. The disclosed embodiments should not be limited in communication nomenclature or protocol; the disclosed systems and methods are applicable to any system that is accessible by means of a Web browser, or other means of communicatively coupling one device or server to another.

According to the embodiment, users 104 are people who visit a website associated with system 112 but neither buy or sell products and services on website 112. Consumers 106 represent the buyers of the goods and services via website 112. Retailers 108 exhibit products and services to be marketed and sold online through website 112. Website 112 provides a common platform to users 104, consumers 106 and retailers 108 for reviewing, buying and selling of goods and services online. Further, website 112 provides a search engine and a reward point system for users 104, consumers 106 and retailers 108. The search engine and the reward point system are described in detail in conjunction with FIG. 3.

According to one embodiment, retailers 108 reach their consumers 106 using website 112. The online behavior of user 104 and consumer 106 may be monitored through an application on users' 104 and consumers' 106 web based agent, say a computer workstation on which user interface 109 is provided. The web-based agent, a software program, operates in the nature of a tool, toolbar or similar method, which not only tracks the users/consumers use of the Internet for purchases and browsing, but further stores information in relation to such use in a local (on the workstation) file or database. When the user/consumer logs into the system 102 via website 112, the local agent uploads the data previously stored in the file or database. Examples of the type of data that may be exchanged include that set forth above relative to the database records. It will be appreciated that only data for some records or fields may be updated via an upload (e.g., track mode data such as: time spent on a website; number of pages viewed; reviews entered; advertisements, promotions and/or surveys clicked and availed; and products purchased at partner sites or retailers).

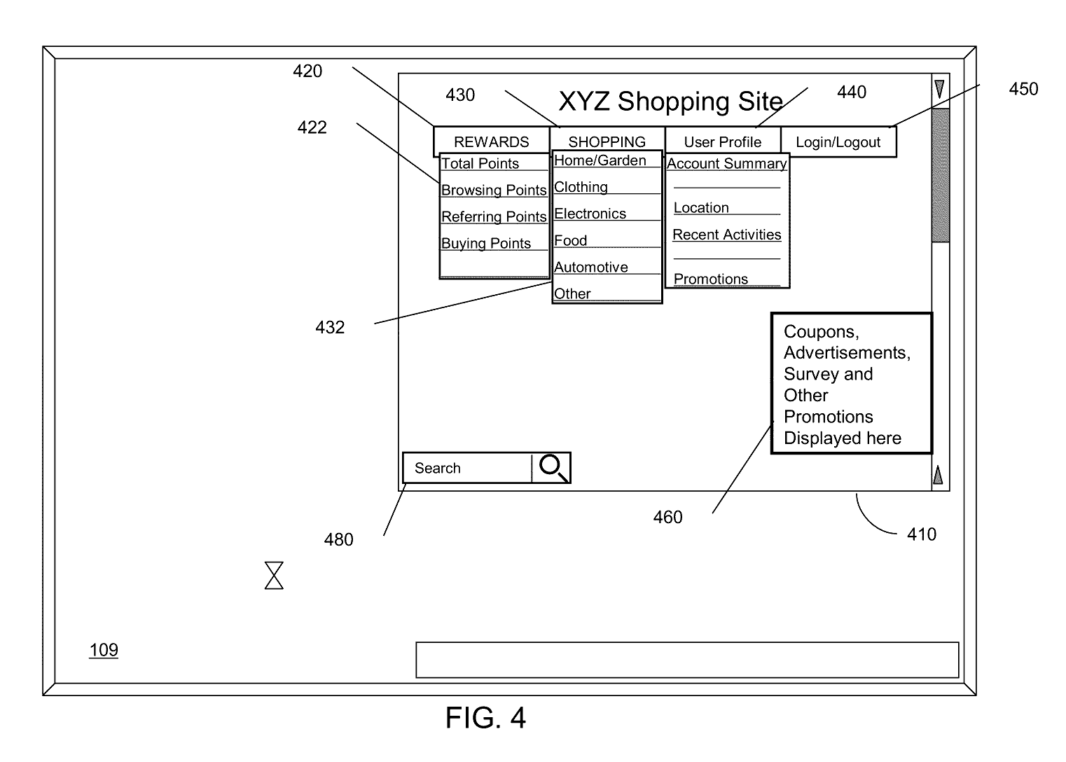

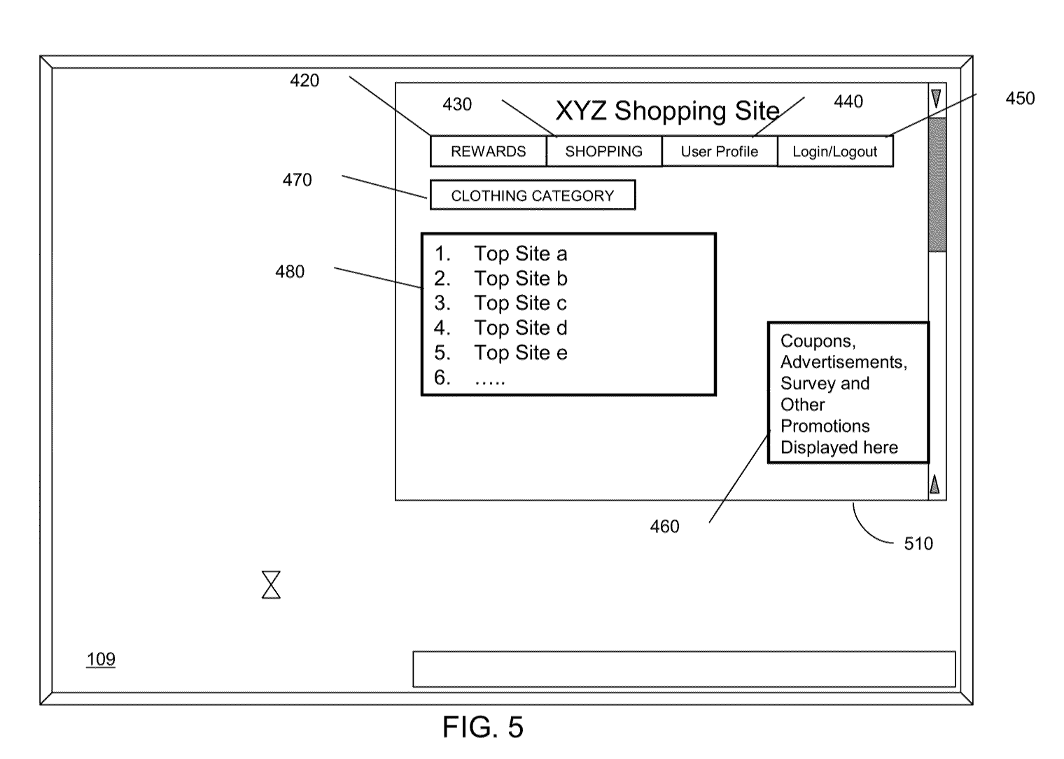

In one embodiment, this application may be provided as software, such as a toolbar which can be integrated with the web browser installed on the web based agent. For example, in the case of a toolbar or messenger-like window, the user may or may not need the browser to be open in order to permit the agent to monitor and exchange activity with system 102. As illustrated in the exemplary interface 109 for the XYZ Shopping Site (iuneek.com as depicted in later interface figures) seen in FIG. 4, there is shown a browser window 410, in which the user may select button 420 to see the current rewards points (selecting in drop-down or roll-over menu 422 from total, browsing, referral or buying points). Similarly, the user may use roll-over button 430 to see the menu 432, which includes various categories for browsing/shopping. In response to selection of, for example, clothing in menu 432, the user will be presented with the web page 510, as depicted in FIG. 5.

Referring also to FIG. 5, shown therein is an interface for selection of one or more clothing retailers as identified by the category in field 470. The top retailers meeting the clothing characterization are then listed in region 480, preferably in order (where the number of retailers may be a factor of the user's membership level as discussed below). As with any of the retailers that are provided via the website, such retailers are included in the interface based upon their rating relative to local consumers. In other words, a consumer logging in to the system would have a zip-code or other location identifier that would enable the system to determine a location or geographic region from which the “top” list (e.g., top-20, top-10, top-5, etc.) would be generated. In other words, the user could be presented with a list of the top-10 clothing retailers in the Syracuse, New York area if the user is identified as being in the Syracuse area. Similarly, a consumer in Chicago would be presented a list that is determined relative to Chicago-area consumers. It will also be appreciated that the information listed in the “top” display (e.g., in response to a user inquiry), may be the top, or most frequently browsed, URLs along with top sites. Hence the embodiments disclosed herein are equally applicable to both upper level websites (e.g., domains) and specific pages or URLs.

The top-10 lists for each category of retailers and service providers (e.g., list in region 480 of FIG. 5) is determined as a result of consumer preference and use as indicated by statistical information obtained from consumers in a region (e.g., metropolitan locations and surrounding geographic regions). It will be appreciated that one or more regions may have usage statistics combined in the early stages of system operation in the event that there is insufficient data to identify a top-10 listing.

Further depicted in FIG. 5, for example in region 460, may be one or more coupons, advertisements, surveys or other promotions. Each of such items, it will be appreciated, may be used to drive traffic to particular retailers, to assess consumer behavior and motivation in response to the particular items depicted, or to incent users to more fully investigate and/or use the system. For example, a user that has not made an on-line purchase via the XYZ Shopping Site in an extended period of time may be provided with a coupon for one or more of the top-10 retailers depicted in the shopping category selected. In such an embodiment, the coupon presentation could be driven by a consumer's usage data in the database. In another example, a retailer may wish to promote a particular item meeting the user's shopping selection and advertisements and/or coupons may be displayed for such items in response to the user's selection.

Upon initial registration a consumer would be assigned a log-in name and password. Subsequently, the agent described above would be installed and the consumer's on-line browsing and purchases would be monitored. It will also be appreciated that if or when a user logs in via another workstation or perhaps a mobile communication device, a web-interface such as that depicted in FIGS. 4 and 5 may be provided to permit the user to access the website, and instead of tracking the activity via an agent, the activity is tracked by the system while the user is logged in.

The online behavior that is tracked via the browser or agent-based program may include website browsing as well as buying products and services through online stores. For example, user behaviors of interest may include browsing a predetermined website; referring others to the predetermined website; using coupons to purchase items from a website; using coupons to purchase items directly from a participating retailer; participating in online surveys; buying products on predetermined websites; writing reviews of products, overall browsing behavior; actual or trends in purchasing behavior; selection of a promotional (e.g., advertising or coupon link); and user redemption of reward points). Website 112 has a web-interface in which user 104 or consumer 106 could search for various products and services offered by retailers 108. User 104 and consumer 106 could also search for a product from a particular retailer 108. The search feature may be accessed via search field 480, where a user enters a term(s) and selects the magnifying glass icon to initiate a search of all retailers or the retailer site being displayed in the web browser window 410. Retailers 108 could use website 112 for selling their products and services. Retailers 108 can also use website 112 for certain other purposes like advertising the products, which will be discussed in conjunction with FIG. 3.

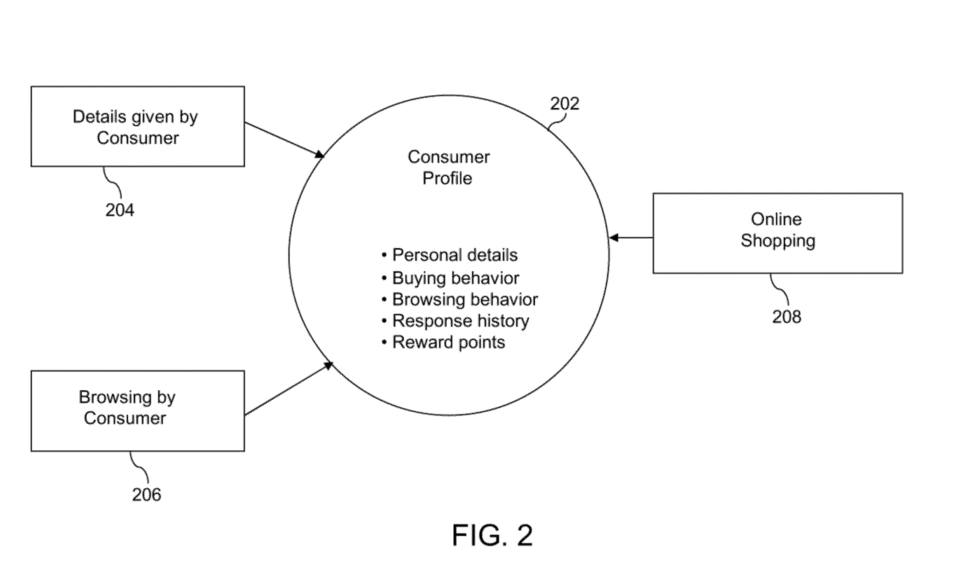

FIG. 2 illustrates a method of collecting information from various sources to create a consumer's profile on the system. The consumer profile contains various psychographic and demographic details of a consumer 106. For example, the psychographic information may be determined from usage, or may also include survey data when the user was asked questions pertaining to preferences. The demographic data, while perhaps available from the users of the system themselves, may also be obtained (e.g., purchased) from other databases that are known. Data for consumer's profile 202 is collected from details given by consumer 204, browsing behavior of consumer 206 and online shopping 208 using website 112. The profile information may be stored in a database, as noted above, which may be part of memory unit 116 (FIG. 1) or a separate memory or other storage medium connected to and/or accessible by system 102. Online shopping 208 refers to any buying or selling of products and services which is being assisted by website 112. As an alternative noted above, if an agent is operating on the user's workstation, the on-line buying or selling operations may be monitored without requiring the user to actually purchase via website 112, although the agent would collect and report similar transaction data back to the system 102.

As suggested above, an agent operating on a consumer's workstation (e.g. a toolbar) may be employed to monitor or tracking browsing and purchasing activity, and to report the same to the system for storage in a database. In one embodiment the information may be aggregated to collectively indicating consumer behavior for one or more advertisers. In another use, the data collected from the agent and stored in the database may be used to allocate reward points to consumers for browsing, purchasing and other activities. While the agent may monitor or track such activity and report it to the system 102, as represented by operations 206 and 208 in FIG. 2, the reward points would be automatically allocated by the system and a database entry would be updated periodically to reflect the allocated (or redeemed) reward points for a particular consumer.

Consumer profile 202 includes information of consumer's 106 personal details, shopping behavior, browsing behavior, response-history and reward points awarded to consumer 106. Further, personal details of consumer 106 includes information on various demographic and psychographic variables such as consumer's 106 age, gender, location and interests. The shopping behavior includes information related to product and services bought by consumer 106, money spent by consumer 106 for buying or renting the products and services through website 112. The response history involves information of how a particular consumer 106 responded to a promotional offer in the past. The concept of reward points is explained in detail in conjunction with FIG. 3. Further, consumer profile 202 is stored in memory unit 116. Consumer profile 202 is used for targeted marketing and sending promotional offers which has been explained in conjunction with FIG. 3.

FIG. 3 represents a schematic diagram of various services offered by system 102 used for targeted online marketing. More specifically, the services offered by system 102 include online surveys 304 among a selected group of users 104 and consumers 106, report generation 306, generating user, consumer and retailer statistics 308, and online advertising 310. The reports may be generated by applying segmentation and clustering methods on user 104, consumer 106 and retailer 108 statistics. In one embodiment, it is contemplated that a report generator, operating under the programmatic control of processor 118, receives criteria for the desired report(s) (e.g., date range, geographic area, consumer information, etc.) and then compiles or generates the reports based upon an analysis of the database for the relevant information. For example, the reports may break out user purchasing behavior based upon age or other factors that may be used to segment and analyze transactions based upon purchasing behavior. This information may then used by retailers 108 to target specific consumer groups and to formulate sales strategy. The reporting of data or statistical information will depend on the retailer on how they want to use the information. Ideally, the retailer can use the information from reports to formulate advertisements, coupons and promotions towards the users most frequently visiting the retailer's site and who are in the target group of the retailer. Alternatively, the retailer can also target the users in a target group but who do not frequently visit the retailer's site. In designing the advertisements, coupons and promotions, the retailer can either use data analysis/reporting services of the shopping site or can do it through other means. The retailer can also use the site (or other means) to survey a sample of users to get their feedback on any aspect of the behavior that the retailer might notice through the reports provided.

The online survey 304 includes opinions about various products and services which user 104 or consumer 106 provide. Report generation 306 involves any analysis done using the database of consumers' profile 302 and market surveys 304. Report generation 306 is generally done on request of a retailer 108 or any person making such a request. It is further contemplated that some requests or queries may be requested via the retailer's web interface, and the results similarly displayed or provided for download though the website as well. According to another embodiment of the system, statistics 308 may include the pages viewed per visit by users 104, consumers 106 and retailers 108 browsing website 112, the average time of stay on any particular website by a particular user 104 and consumer 106, the number of users 104 and consumer 106 who may be online and the websites which are viewed by the majority of users 104 and consumers 106 after visiting a particular website. However, it would be apparent to a person skilled in the art that various other parameters could be used for determining the statistics. Statistics 308 which are provided to user 104 consumer 106 and retailer 108 is predetermined and depends upon the kind of membership they have obtained with website 112. For example, a plurality of membership levels may be available, with different levels offering different information, reporting, etc. In one embodiment a retailer may select from one of three memberships—basic, gold, platinum. The higher level gets more information, more statistics, etc. For consumers, the level of membership might determine the type of information they are provided. A base level, perhaps offered at no cost) might provide just a listing of the top retailer in a particular category, whereas paid memberships might provide an increased number of top retailers (e.g., top-10, -20, etc.) As noted previously, the membership of website 112 may subscribe by creating an online account via website 112. Further, the statistics and other services may be available by any individual by paying a periodic (e.g., monthly) fee or a per usage charge.

The statistics and consumer profile of various consumers 106 can be used to provide promotional offers to them. For example, a retailer 108 wants to sell antique items whose price is $5000. Further, retailer 108 wants to reach out to consumers 106 who have past record of buying expensive antique items having a price of $3000 and above. This information can be sought from website 112 by paying service charges to website 112 and in response receiving a listing of such consumers, or perhaps having the retailer's offering sent via system 102 to such consumers (that way the retailer does not directly receive the consumer's e-mail address(es). Here, website 112 maintains a database in memory unit 116 about consumers 106, which have a past record of buying expensive antique items having a price of $3000 or above. Hence, retailer 108 can easily reach out for the promotion of the specific products to specific consumers 106. Retailer 108 may send out advertisement through emails, SMS or any other available means for which the consumers have provided the contact information in their profile.

Further, retailer 108 may also customize the webpage as viewed by a specific consumer 106 on website 112 and advertise only selected products and services which match the consumer profile 202, thus providing targeted marketing to consumer 106. Similarly, the consumer's experience at website 112 provides the most popular sites specific to the user's location and may also be based upon other information. The retailer may also target coupons, advertising and promotions based upon user information. Retailer 108 can also get information about demography of people buying antique items from website 112. Retailer 108 may also conduct an online market survey and get opinions about the products through website 112.

The disclosed system and methods also provides a mechanism to get rankings of various websites based on popularity of websites at an aggregate or disaggregate level. In one embodiment, a criterion that may be employed is time actively spent on website during a particular time interval. In other words, how much of the hour from Noon to 1:00 PM was the user actively browsing a website or engaged in similar on-line activity. The time spent may also be weighted differently based upon the activity. For example, a different weighting might be applied for simply browsing versus browsing resulting in purchasing, or browsing resulting in a contact or information request, etc. Moreover, it is contemplated that the browsing must be active, and a timer(s) may be employed to determine if the user has simply left the website open in a browser or is actually interacting with the website. In the mechanism, when a user 104 or a consumer 106 conducts a search in any web search engine, the individual is presented with a list of related websites. The list of related websites can be presented in order of decreasing rank, where rank of a website is calculated based on the total number of visits, time spent on the site, rating of the site by users and/or purchases by all users 104 and consumers 106. Further the rankings could be based on the number of users 104 and consumers 106 visiting the website from a certain geographical area. Users 104 and consumers 106 may also view the ranking of websites based on various categories. Some example of the categories that may be used to rank websites include overall, and books, jobs, news, travel, electronics, and arts. Ranking may also be done based on search terms. For example, a user 104 or a consumer 106 searches “best travel reservation site” and gets websites “A”, “B” and “C” as the search results. The individual is presented websites “A”, “B” and “C” in decreasing order, where the ordering is on the basis of statistics gathered from the actual users and consumers on their interaction with these sites in the past. Ranking can be calculated based on parameters such as time spent by the users 104 and consumers 106 on a website or number of users 104 and consumers 106 online at a time in a particular website.

The disclosed system and methods may also offer users 104, consumers 106 and retailers 108 affiliate programs, which encourage them to use website 112. One example of an affiliate program would be exchanging the link of the shopping site(s) with others and/or providing some percentage of the amount of items bought by the consumers at the partner sites and/or paying some amount for directing traffic towards the shopping site(s).

The disclosed embodiments also may include a reward point system. The reward points are earned by users 104 and consumers 106 when the user 104 and consumers 106 engage in a variety of online activities via the website 112. Online activities may include browsing the website 112 as described above (activity may be monitored), referring people to the website 112, using coupons to purchase items from the website 112 or directly from a participating retailer, participating in online surveys, writing down reviews and buying products on partner websites.

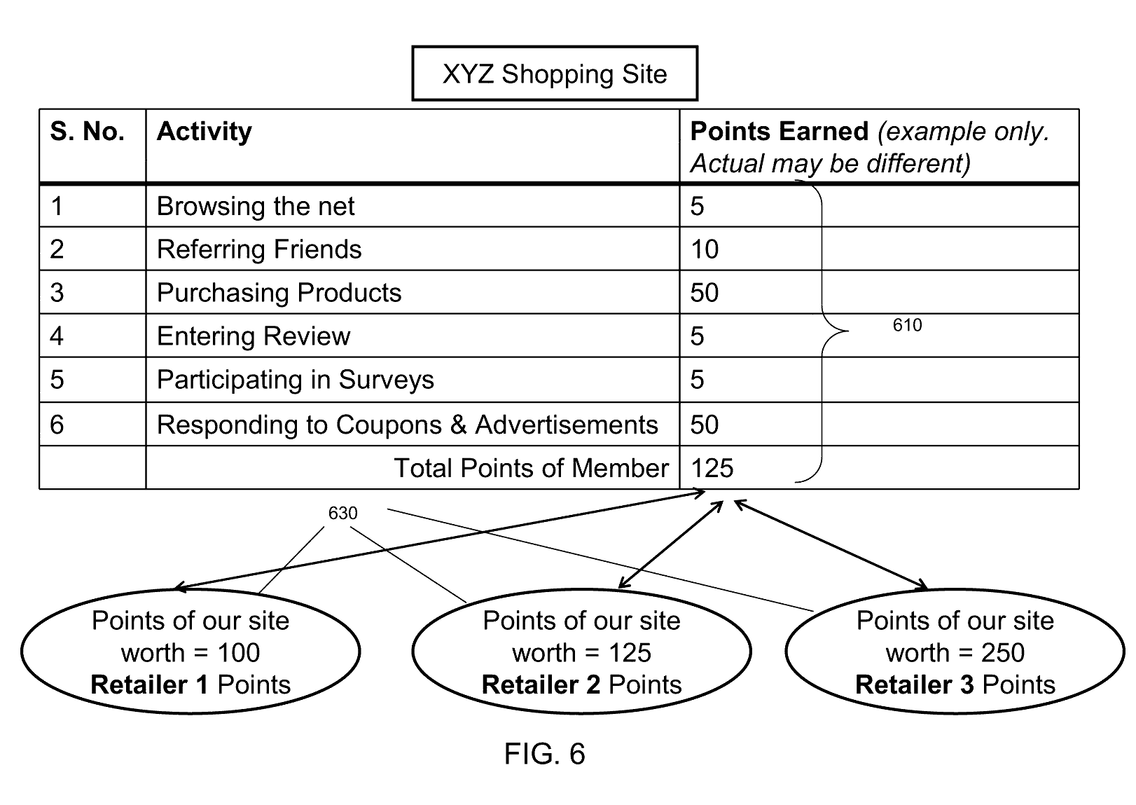

FIG. 6 provides an example of a user's usage report, indicating how much a consumer had used the system 102 and the points accumulated as a result of such use. The data in region 610 of the report illustrates a breakdown of the user's point accumulation, and shows the total points available to the user. It may also be possible for users to redeem or transfer pre-existing or accrued points from participating retailers in order to convert them to reward points for the system—points that may be available for use at a range of retailers, etc. As an example, the bottom of the report page in FIG. 6 may include links 630 to a plurality of retailers, with an indication of the number of points that the user's total point may be exchanged/redeemed for with the specific retailer. As will be appreciated by the illustration, the retailers may offer to exchange points from the shopping site at various conversion rates set in discussion with the retailers individually.

Partner websites are other websites which are using the website 112 to sell their products and services to the consumers 106. The means for using includes without limitation providing a link onto the website 112. However, it would be apparent to a person skilled in the art that various other means could be used. Users 104 and consumers 106 may redeem their reward points for various offers via the website. The offers may include gifts from a catalog based on level of reward points, discounts on websites to buy items and weekly lottery draws (to encourage initial use of the site). There is also a provision, as noted above for redeeming or swapping of reward points between two different loyalty card programs i.e. a consumer 106 can earn reward points from one retailer 108 and redeem those reward points with another retailer 108. In a loyalty card program a consumer 106 earns reward points when the consumer 106 buys products or services from a retailer 108. These reward points can be redeemed for various offers given by the retailer 108.

It will be appreciated that the details of any redemption or swapping operations may be handled under the programmatic control of the system 102, and that a database, database table, or other memory structure, for example those depicted in FIGS. 22-23, may be employed to facilitate such redemption or swapping. Included in the database entry would be the ratio or percentage of points for transfer (redemption or swap) to permit conversion to a “standard” reward point scale as used by the system. If a user then wanted to swap such points to another retailer, a similar conversion would be completed. Moreover, it will be appreciated that a different conversion factor between retailer points and reward points in the system may be used based upon whether the points are being credited to or debited from a consumer's total, the particular retailer and other factors. As noted above, such conversions are illustrated at the bottom of FIG. 6.

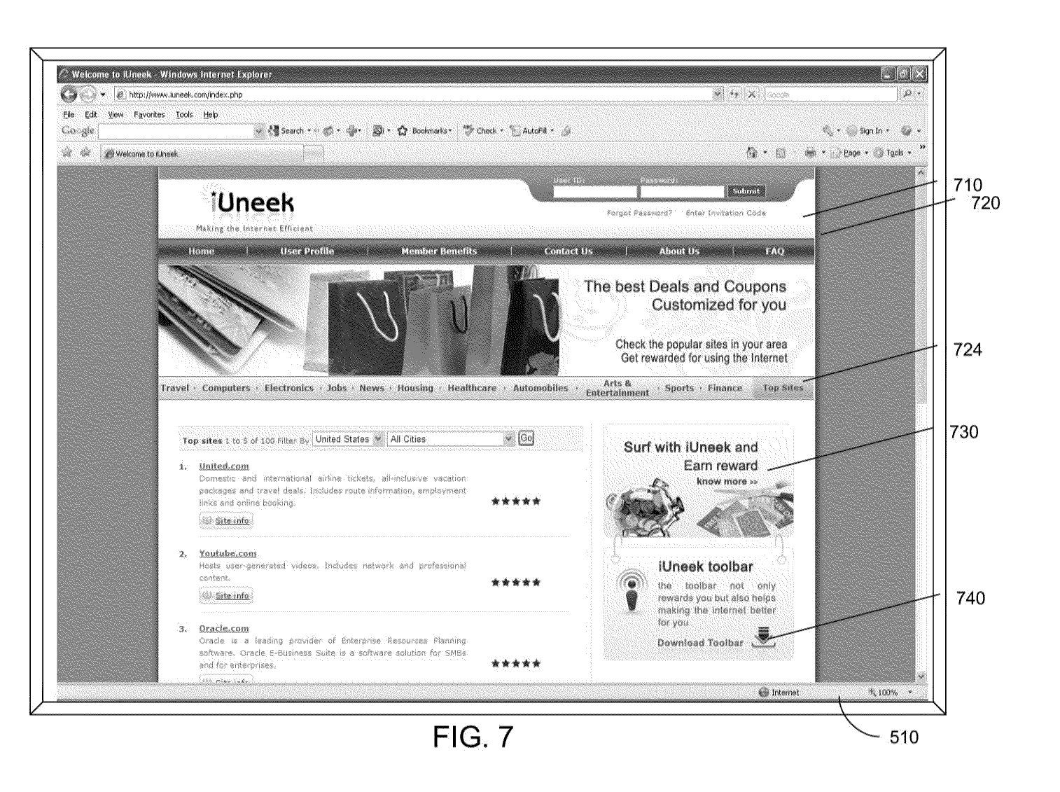

Having described the operation of the system and method attention is now turned to a specific embodiment illustrated through user interface screens as depicted in FIGS. 7-14. As will be appreciated, several of the screens depict items similar in nature to that which is set forth and described above in FIGS. 4-6.

Referring to FIG. 7, depicted on page 510 is a user interface for an exemplary home page. The home page 710 includes a top navigation bar 720 and a lower navigation bar 724. It will be appreciated that the various links on the respective navigation bars are to facilitate navigation to one or more aspects of the available website pages displayed at the interactive search website, referred to in the illustrated examples as “iuneek.com” or “XYZ Shopping Site.” In addition to the top navigation bar 720, additional links 730 provide further information for prospective users. Moreover, the toolbar or agent described above may be downloaded at link 740.

Referring also to FIG. 21, depicted therein, along the top of the user interface screen 510 is a toolbar 2110. Once someone installs the toolbar and creates a username and password, the toolbar starts to gather the information on sites visited by the user. The figure illustrates a toolbar for a user named “Test.” While a toolbar may be installed on a user's computer, it is important to note that site may also be accessed by a registered user from anywhere even without the toolbar. However, only when the user has the toolbar installed and logs into his/her account, is information gathered on sites visited. When the user logs in without the toolbar, no browsing points are given other points are awarded for referrals, buying, for using coupons and promotions, etc.

Although it should be appreciated that various aspects or elements of the toolbar may be available, and that the toolbar itself may also be customizable to some extent, as illustrated the toolbar 2110 includes a welcome acknowledgement of the user's name, followed by four fields. The first three fields are pull-down menu fields that allow the user to specify country, city and a category as parameters for a search to be conducted. The rightmost field is left blank and is intended to permit the user to enter a search term(s) that, in conjunction with the other parameters, will be used to conduct the search when the “Search” button/icon is selected or the “enter” key is pressed. The indicator region in toolbar 2110 (shown as “active” in the figure) is intended to indicate whether a user is engaging in activity that results in accumulating points. When this indicator is “turned on” by the user and the status turns to “inactive,” then no user browsing activity will be recorded in the database and the user will not be able to accumulate the browsing points.

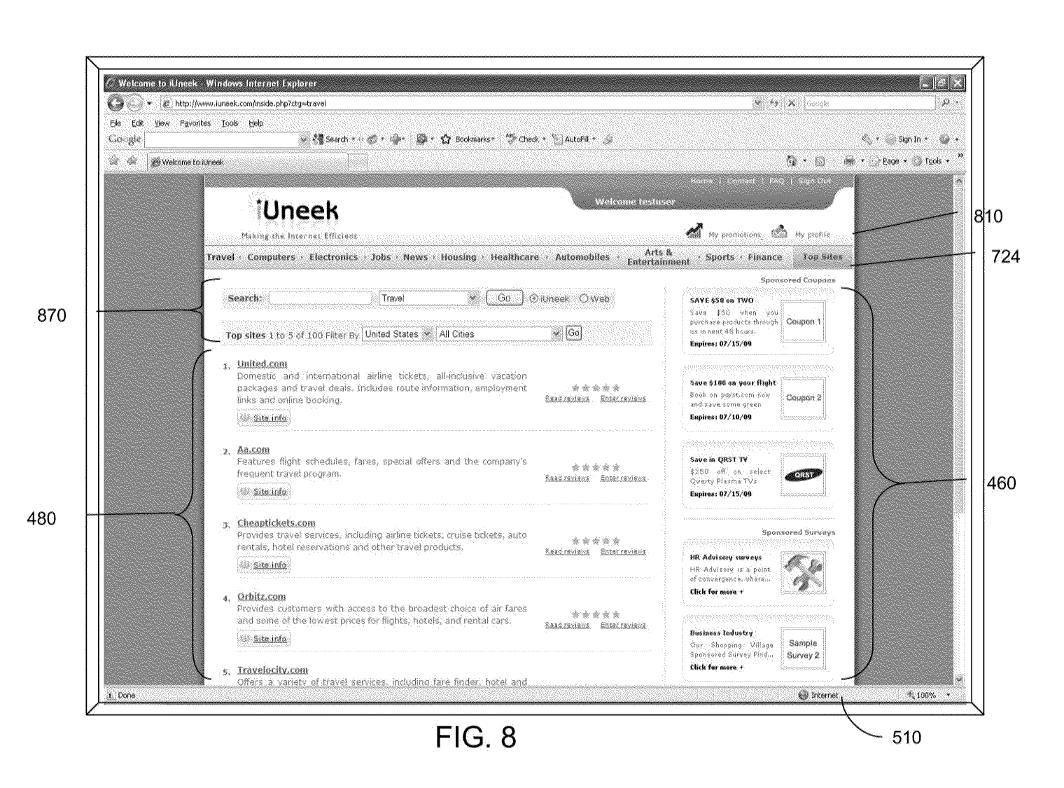

As an example of the operation of the system, upon selecting the “Travel” link in toolbar 724, a page 810 is depicted as illustrated in FIG. 8. Page 810 in turn illustrates the “top” five sites browsed sites by users of iuneek.com under the travel category. Links to the travel sites are provided in region 480. In addition, as previously described relative to FIG. 5, page 810 includes coupon and advertising links along the right side in region 460.

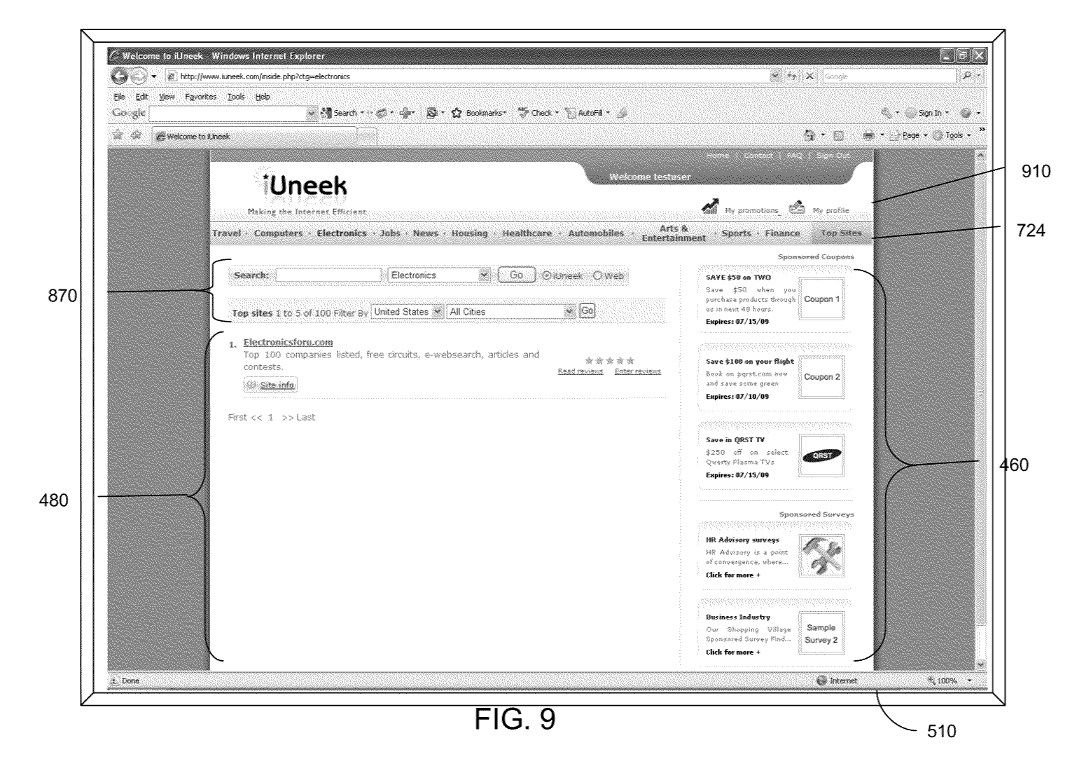

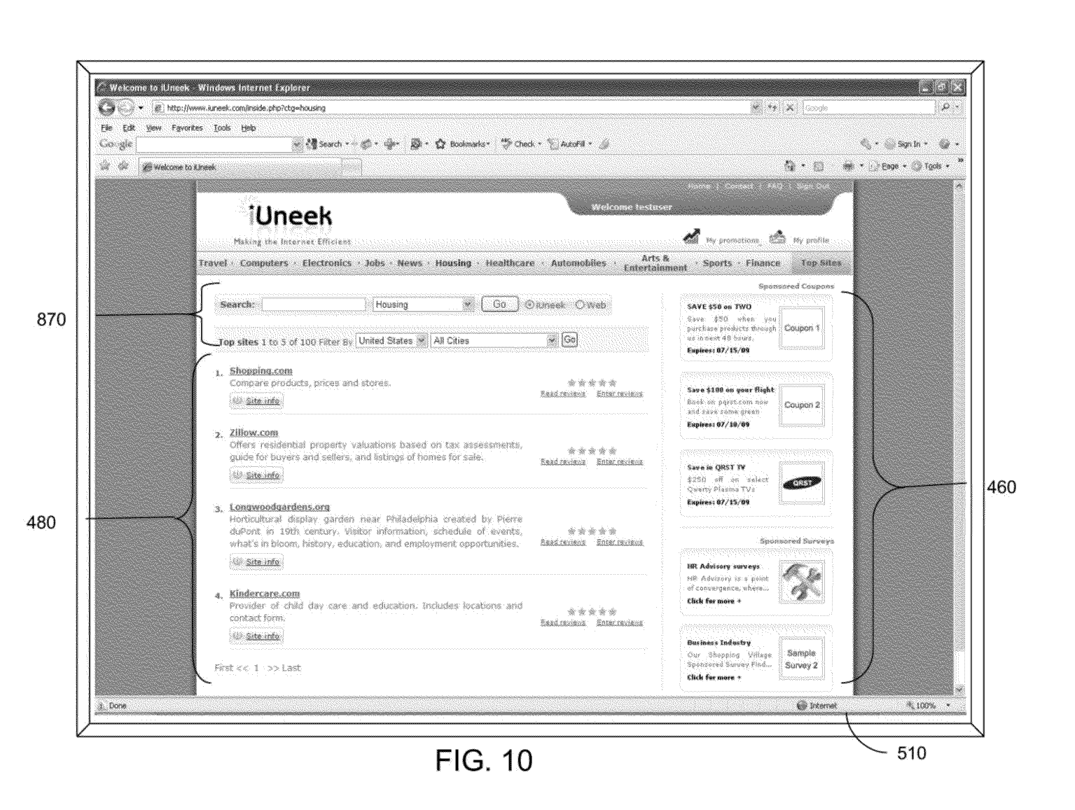

Referring next to FIG. 9 there is depicted another example of the operation of the system. Upon selecting the “Electronics” link in toolbar 724, page 910 is depicted as illustrated in FIG. 9. Page 910 in turn illustrates the “top” electronics-related sites browsed sites by users of iuneek.com. Links to the electronics sites are provided in region 480 and, similar to FIG. 8, coupon and advertising links are provided along the right side in region 460. In a similar manner, page 510 in FIG. 10 provides the top listings for housing related websites.

As will be further appreciated by the search interface in region, searches may be further controlled or limited by geographic region, keywords, search scope (iuneek or Internet-wide), category, etc. by entering or editing the various fields in region 870.

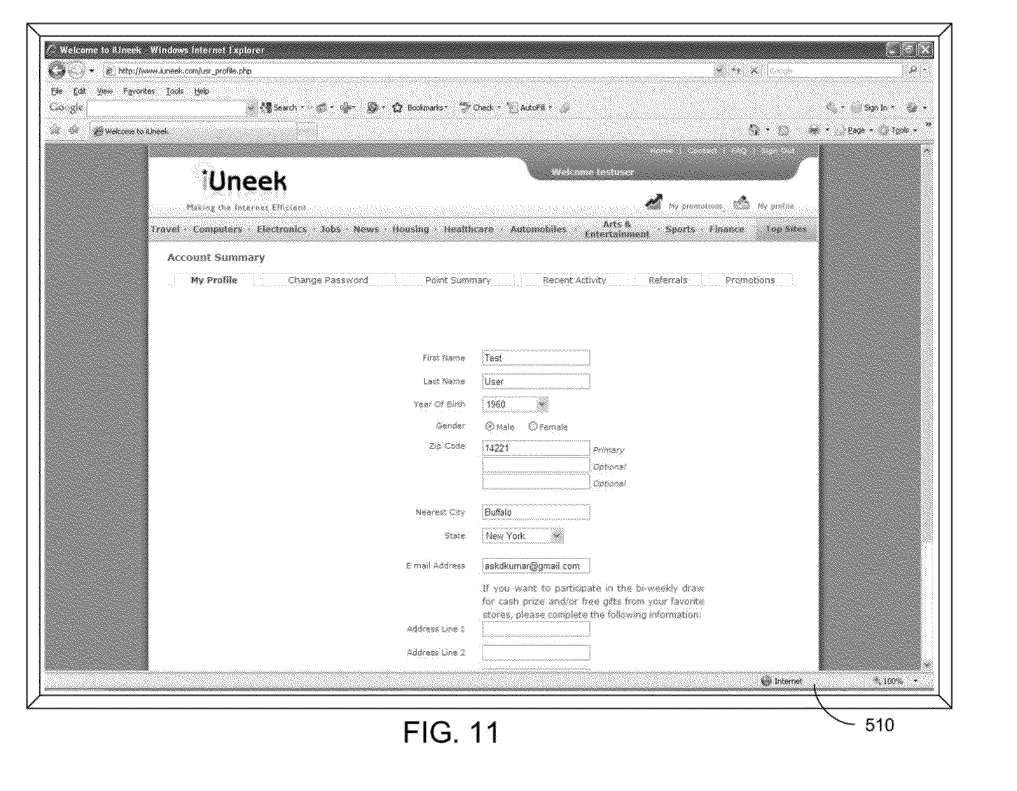

Considering, next, FIG. 11, depicted therein is an exemplary page depicting a user or consumer's profile, including fields corresponding to entries in the system database. Identification fields include First Name, Last Name, Year of Birth; location fields include primary and optional additional zip codes for geographic searching as well as address fields; and an e-mail address is included for promotional or other contacts. As will be appreciated additional fields, preferences and the like may be set forth and entries facilitated on the profile page of FIG. 11.

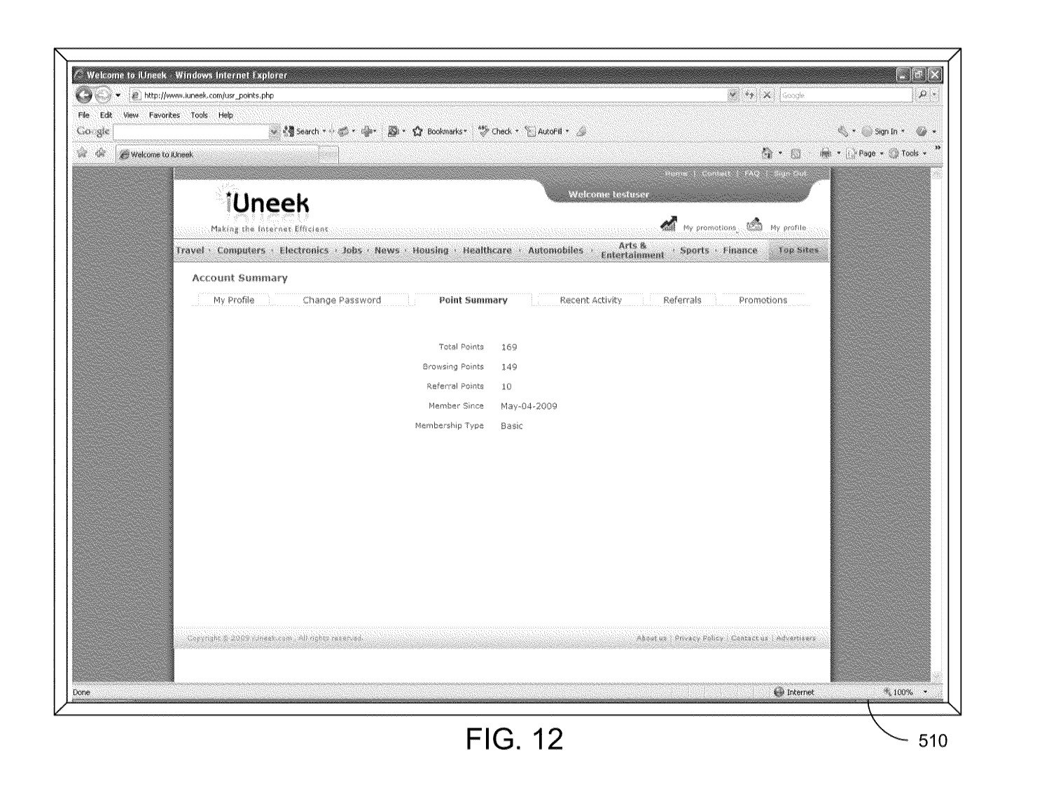

As previously described relative to FIG. 6, the user/consumer may be kept apprised of reward points earned for browsing, purchasing, etc. and the representation in page 510 depicted in FIG. 12 is intended to illustrate such a report. As part of a user's account summary, the report includes the total reward points as well as the subtotals for browsing and referrals. It will be appreciated that other subcategories may exist and may or may not be reflected in the report. For example, a 10-point sign-up bonus is not reflected and results in the total being 10 points greater than the sum of the subtotals.

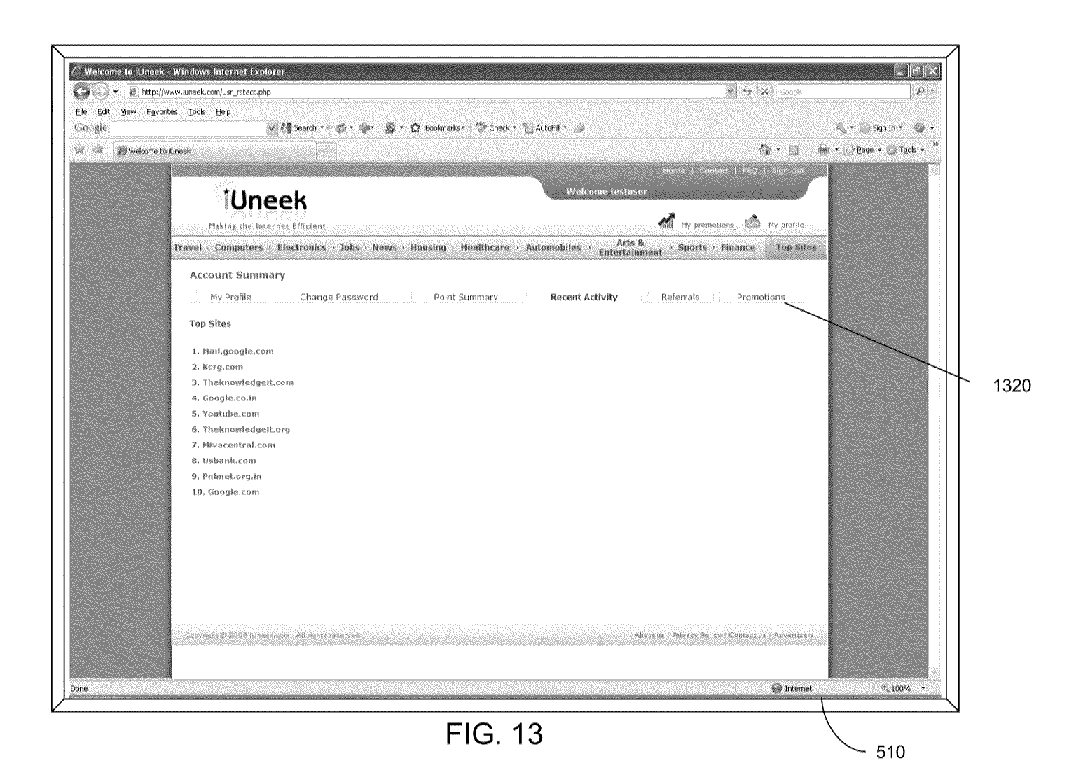

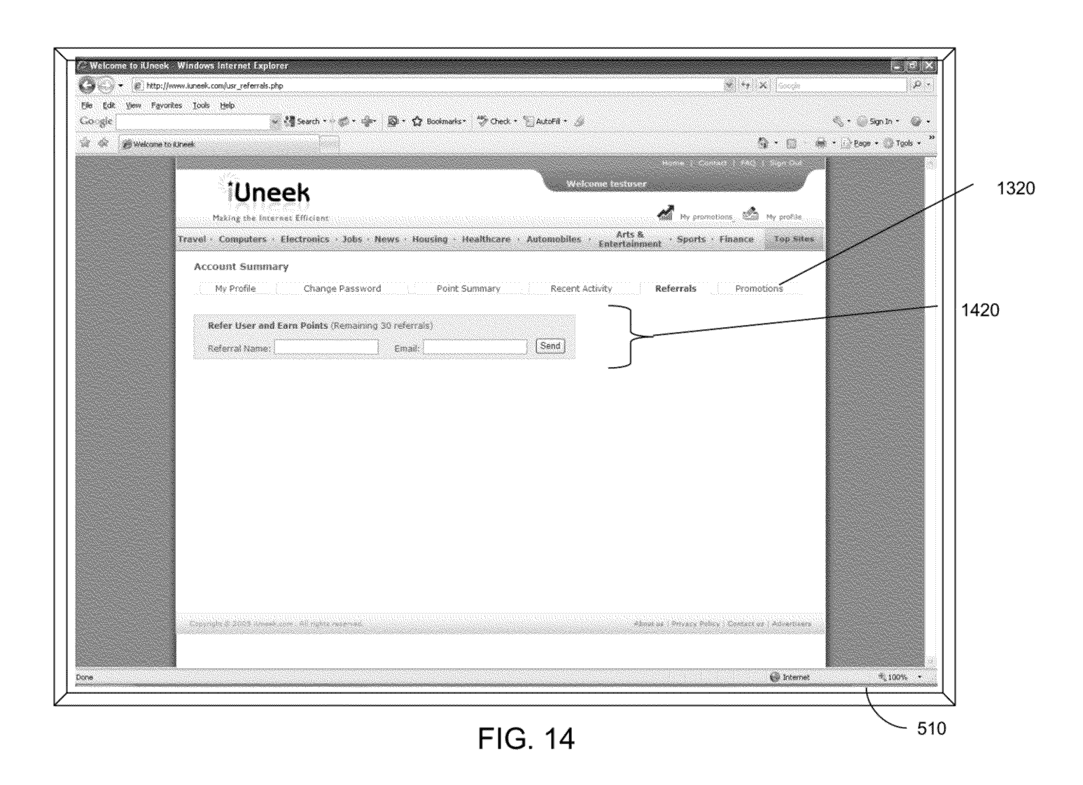

Referring next to FIG. 13, depicted therein is another user account screen depicted on page 510. In this case, the page indicates recent browsing activity by the user, rankings the “top-10” most frequently browsed sites, listed in order by the number of times browsed. It will be appreciated that frequency of browsing may be aggregated (for an entire site/domain) or disaggregated (based upon a specific URL). Also referring to FIG. 14, depicted is a referral page whereby a user or consumer is able to enter referral information into the fields of regions 1420 so that the system may automatically send a contact e-mail to the referred party and invite them to join the service. Moreover, upon adding a referral the referring party is credited, as noted above, with reward points.

As is also see, for example in FIGS. 13 and 14, a “Promotions” link 1320 is present on the user pages. Selecting the link and proceeding to the Promotions page, a user will see coupons that are available. These coupons and other promotions are all those that are available to a particular user, whereas the promotions (coupons, surveys, advertisements etc) that are shown on the right hand side of the other pages (e.g., region 460 in FIGS. 8-10) is a likely only a subset of those available to the user.

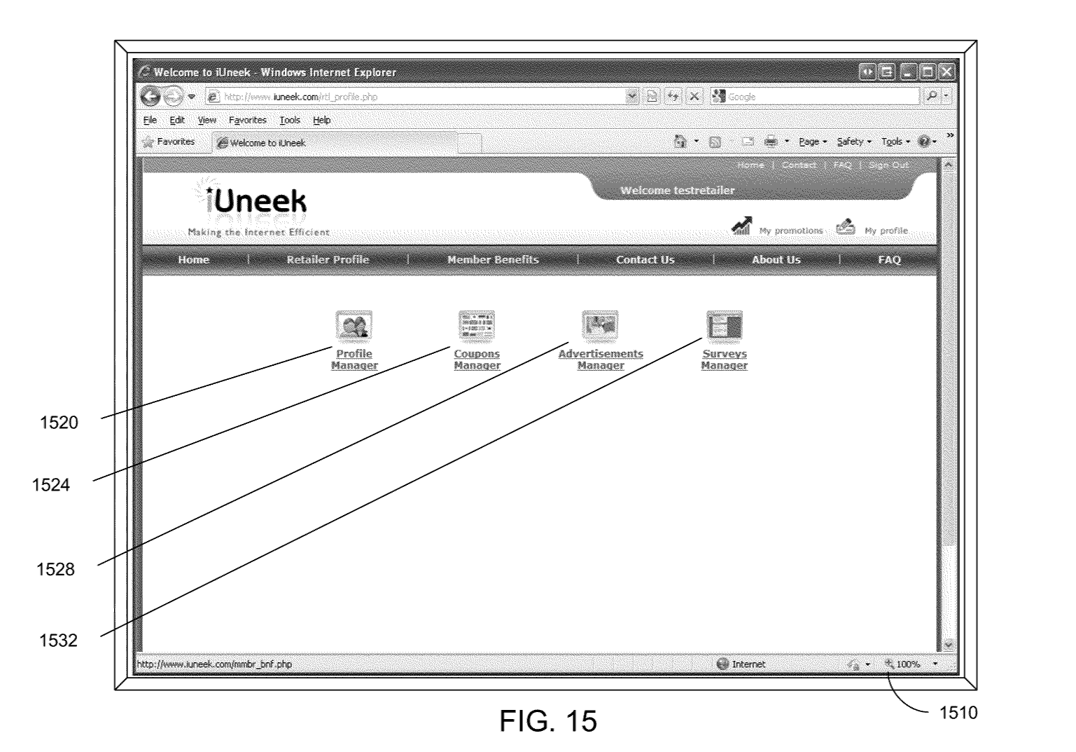

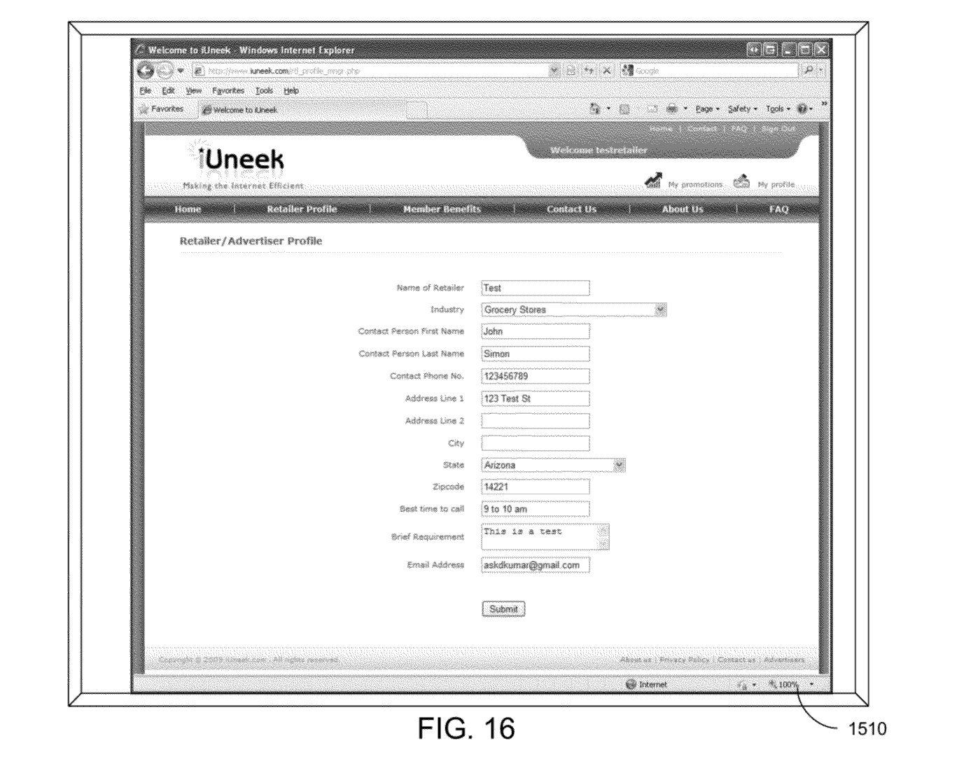

Turning next to FIGS. 15-19, depicted therein are interface screens associated with a retailer user of the system (e.g., anyone who might promote goods or services via iuneek.com). For example, retailers could include not only direct retailers that elect to register and promote goods/services, but the terms also contemplates other companies or even service providers that may partner for coupons, promotions, surveys, advertisements, etc. on the site. In the Profile Manager page depicted in FIG. 16, accessed by selecting the “Profile Manager” link 1520, the retailer is presented with fields into which the retailer may put particular information associated with the retailer's profile. The profile is required in order to register the retailer and to facilitate access to additional functionality such as the promotions and surveys as discussed herein.

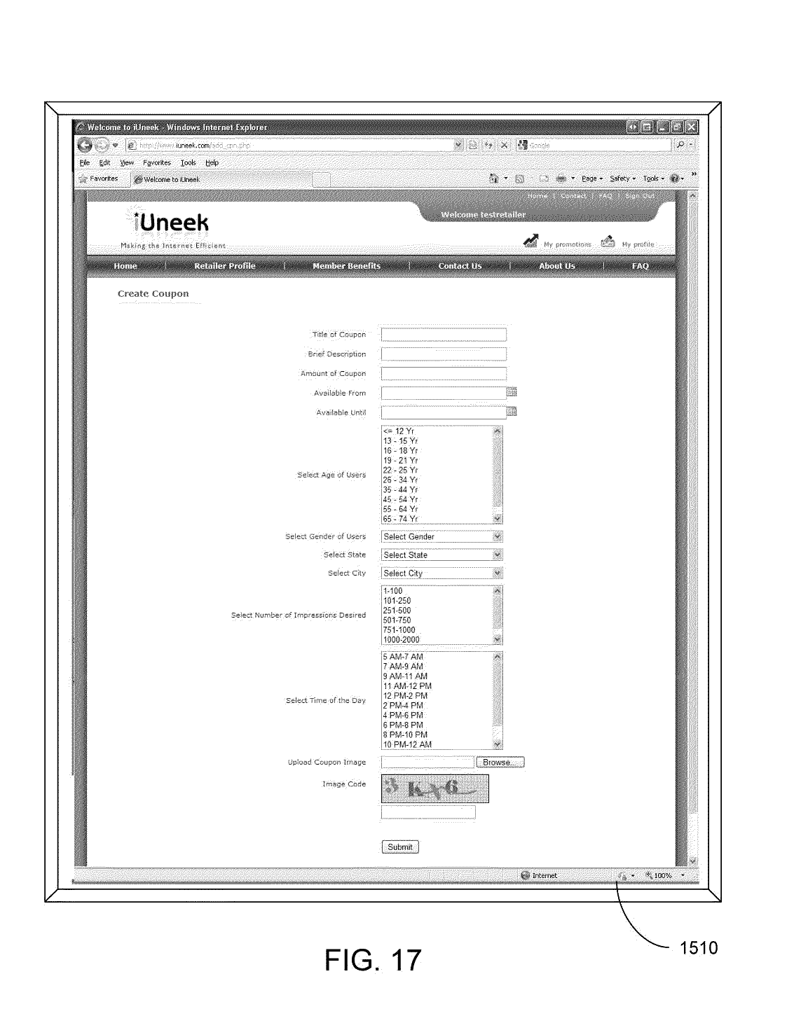

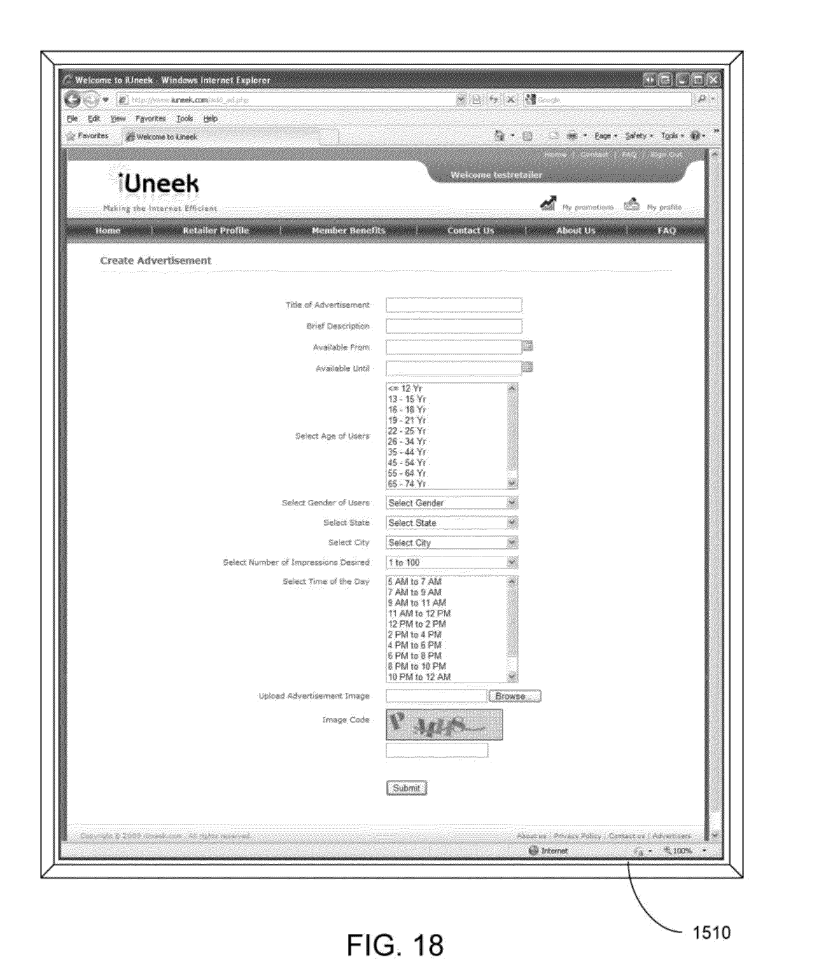

After login in a retailer's selection of the “Coupon Manager” link 1524 will result in the serving of a page similar to that depicted in FIG. 17. In FIG. 17, the page provides various fields into which information associated with a particular coupon offering may be entered. The various fields are believed to be self-explanatory and in some cases may include pull-down or similar menu-type selections that are determined from system parameters. For example, in order to target a particular user parameter (e.g., age), the retailer may make a selection of an age range(s) as indicated in the “Select Age of Users” field. In the case of such a selection, the coupon is then targeted at users that have a profile meeting the indicated criteria. Also included on the coupon page is an “Upload Coupon Image” field that facilitates the uploading of the digital coupon image to the system. As will be appreciated by reference to FIG. 18, a similar interface page is provided to a retailer upon selection of the “Advertisement Manager” link 1528. Again, the advertisements may be targeted based upon specific user profile information.

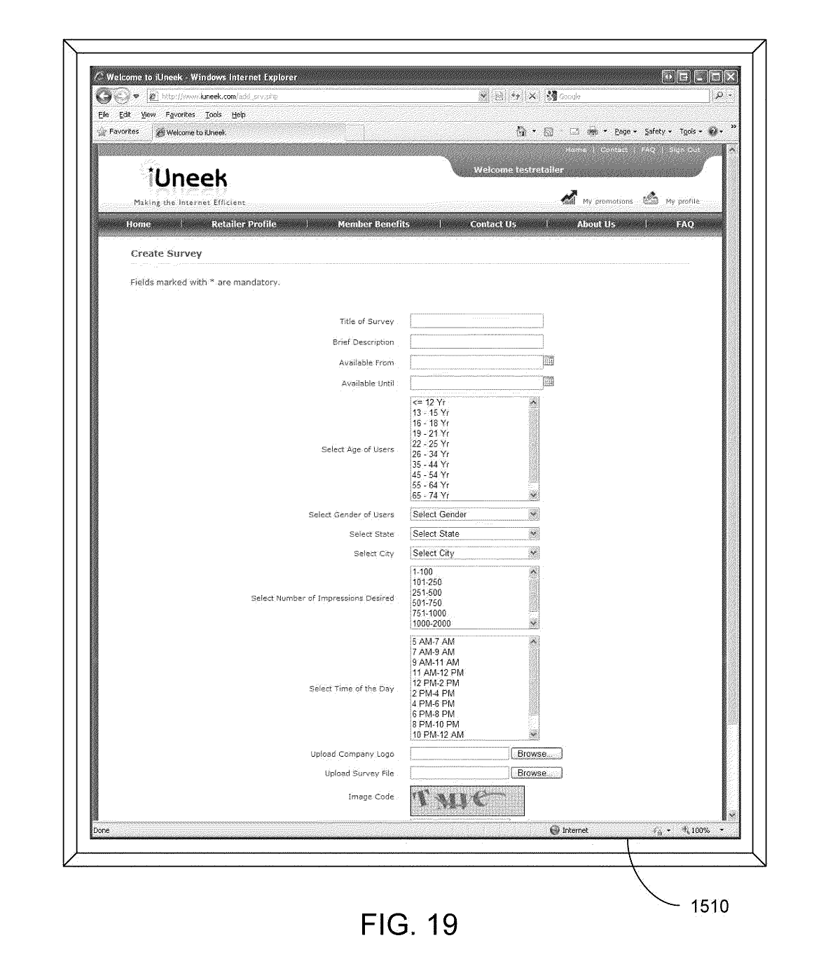

Lastly, if a retail user selects the “Surveys Manager” link 1532 on FIG. 15, the retailer is then presented with a survey creation page such as that depicted in FIG. 19. While the survey itself is separately developed in an html or similar format to facilitate on-line user response, the survey targeting is accomplished or specified using the interface as depicted.

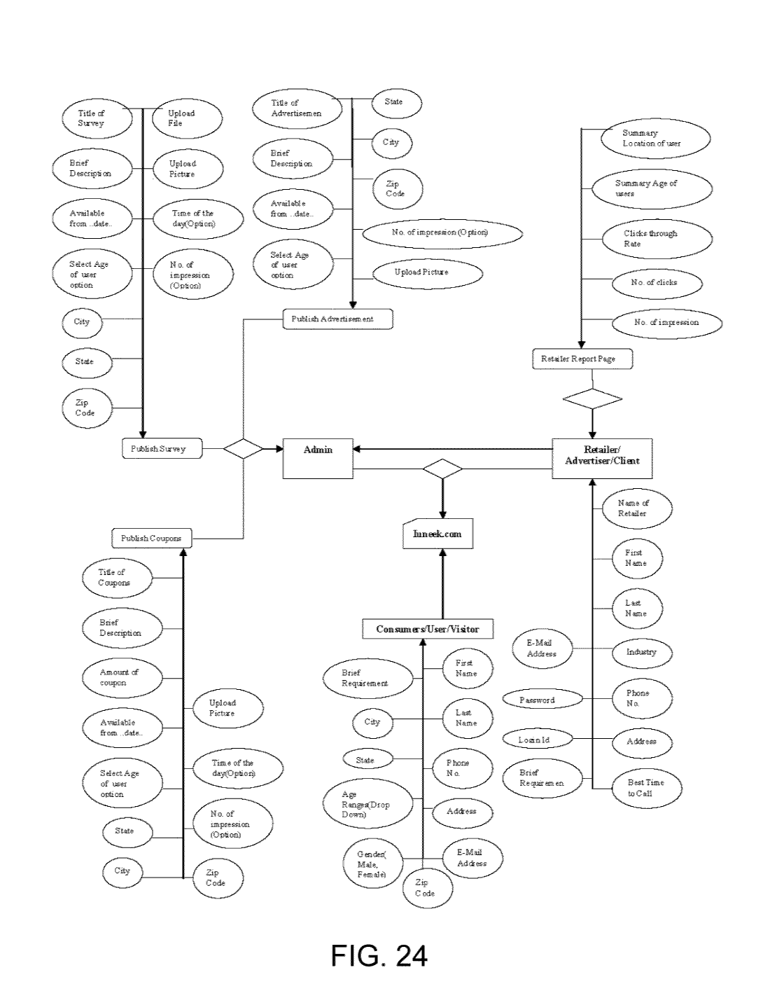

Referring also to FIG. 24, depicted therein is a general data flow diagram depicting the types of system users, as well as the manner in which such users are administered and a sample of the type of information that is collected and/or used for each user. As illustrated in FIG. 24, the actions necessary to carry out promotions and/or reporting are set forth for each option. Moreover, one is able to see the correlation between the data entered on the interface screens described above with the actions represented in FIG. 24.

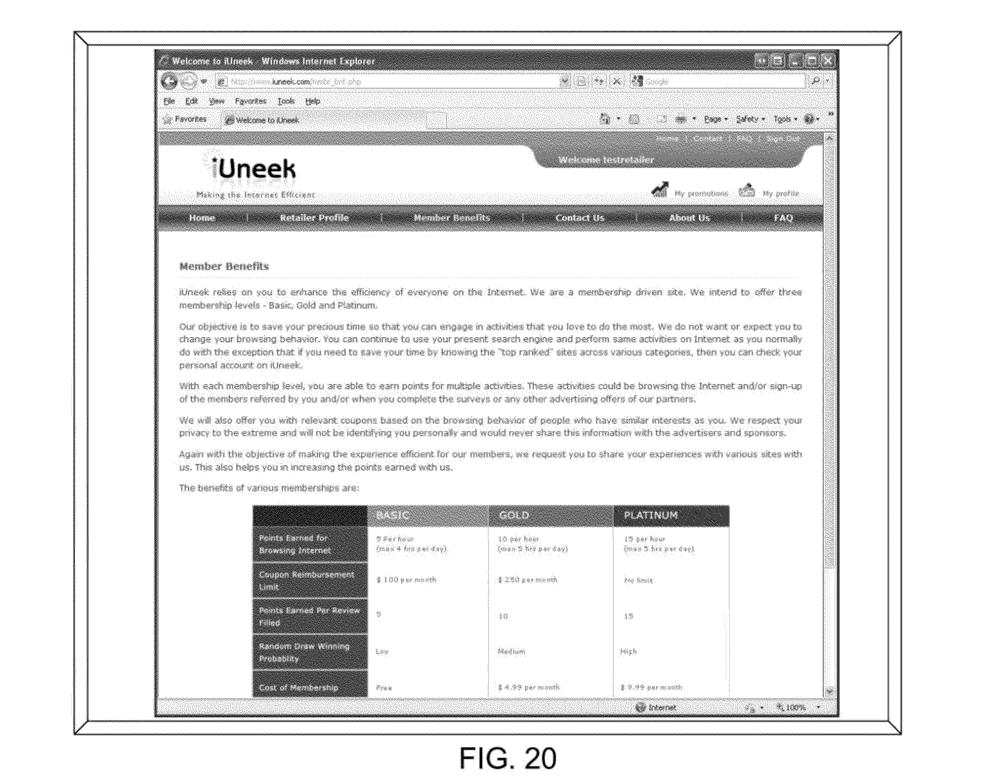

Briefly considering FIG. 20, depicted therein is an exemplary interface screen that would be viewable by a user in order to understand the types or membership that are available, as well as the manner in which reward points are accumulated. From this page a new user would be directed to register and sign-up for the service at one of the indicated membership levels.

As previously noted above, FIGS. 22 and 23 are illustrations of database schema employed for an embodiment of the disclosed system. FIG. 22 is a simplified view of the database illustrating tables and relationships pertaining to management of URL data by the system. FIG. 23 is a simplified view of the database tables that pertain to users, and as will be appreciated includes or is linked to the “url_categories” table that is depicted in FIG. 22.

While example embodiments have been illustrated and described, it will be clear that the invention is not limited to these embodiments only. Numerous modifications, changes, variations, substitutions and equivalents will be apparent to those skilled in the art without departing from the spirit and scope of the description above and the following claims.

What is claimed is:

1. A system for providing targeted online marketing, including:
an application, operating on a server, providing a common platform for consumers and retailers for interaction, said application monitoring at least the browsing and purchasing behavior of a plurality of consumers along with the demographic and psychographic profile of the consumers, said application storing the browsing and purchasing behavior, as well as the demographic and psychographic profiles of a plurality of consumers in a consumer database;
said common platform further providing an interface for consumers to review, and purchase goods or services and an associated reward point system, wherein the amount of reward points accumulated by a consumer are also stored in the database; and
a report generator for analyzing the consumer database of consumer data, including browsing and purchasing behavior, and generating a report reflecting consumer data.

2. The system according to claim 1, further including:
an activity monitor to identify to the system at least those activities by a consumer that are subject to allocation of reward points; and
a database for rewards points tracking system to monitor a consumer's accrual of reward points and thereby provide an incentive for a consumer to use the system.

3. The system according to claim 2, wherein the reward points tracking system provides for the redemption of points from participating retailer reward systems in order to obtain points in the current system.

4. The system according to claim 2, wherein the activities monitored by the activity monitor are selected from the group consisting of:
browsing a predetermined website;
referring others to the predetermined website;
selecting a promotion;
selecting an advertisement link;
using coupons to purchase items from a website;
using coupons to purchase items directly from a participating retailer;
participating in online surveys;
buying products on predetermined websites; and
writing reviews of products.

5. A method for providing targeted online marketing, including:
operating a common application platform to consumers and retailers for interaction, said application platform further monitoring at least the browsing and purchasing behavior of a plurality of consumers, along with demographic and psychographic profile data of the consumers,
providing an interface for consumers to browse, review, and purchase goods or services;
allocating and tracking reward points based upon the activity of a consumer in relation to browsing and purchasing goods or services, wherein the reward points are stored in a database; and
analyzing the database and reporting consumer data, including browsing and purchasing behavior; and
generating a report indicating user behavior.

6. The method according to claim 5, further including tracking and reporting rewards points to provide an incentive for consumer use.

7. The method according to claim 6, wherein the reward points tracking further includes redemption of points from participating retailer reward systems in order to obtain points in the current system.

8. The method according to claim 5, wherein generating a report includes reporting at least one behavior selected from the group consisting of: user
browsing behavior;
user purchasing behavior;
user selection of a promotion link;
user selection of an advertising link;
user selection of a coupon link;
user redemption of a coupon; and
user redemption of reward points.

9. The method according to claim 5, further including ranking and listing URLs based upon user browsing frequency.

10. The method according to claim 5, further including an aggregated ranking of websites based upon user browsing of a plurality of URLs for any website.

11. A method for providing ranked access to websites, including:
operating a common application platform to consumers and retailers for interaction, said application platform further monitoring at least the browsing behavior of a plurality of consumers, along with demographic and psychographic profile data of the consumers,
providing an interface for consumers to browse, review, and purchase goods or services;
tracking user browsing behavior, wherein at least compiled browsing data is stored in a database; and
in response to a user query, analyzing the database, and providing a ranked list of URLs visited by consumers for user review.

12. The method according to claim 11, further including an aggregated ranking of websites based upon user browsing of a plurality of URLs for any website.
